(19) United States
(12) Patent Application Publication
(10) Pub. No.: US 2024/0370809 A1
(43) Pub. Date: Nov. 7, 2024

(54) REALTIME MONITORING OF INTERACTIONS

(71) Applicant: Nice Ltd., Ra'anana (IL)

(72) Inventors: Avital COHEN, Rosh Haayin (IL); Gennadi LEMBERSKY, Haifa (IL); Or GERSHON, Petah Tikva (IL)

(73) Assignee: Nice Ltd., Ra'anana (IL)

(21) Appl. No.: 18/310,033

(22) Filed: May 1, 2023

(51) Int. Cl. G06Q 10/0639

(52) U.S. Cl. CPC G06Q 10/06393; G06Q 10/06395

(57) ABSTRACT

Systems and methods for automatic real-time monitoring of interactions, carried out by at least one computer processor, including: producing a score for each text component of a text representation of an interaction; producing, based on the score for each text component, a score for each of a plurality of time periods of the interaction; producing a score history, including a plurality of the time period scores; and calculating, based on the score history, a real-time indication of the quality of the interaction.

### FIELD OF THE INVENTION

The present invention relates generally to automatically monitoring an interaction in real time and providing a real-time indication of the quality of the interaction, for example, raising an alert if the interaction is negative.

### BACKGROUND OF THE INVENTION

Contact centers may handle large numbers of interactions including data (e.g., voice or video recordings, text exchanges, metadata, etc.) between parties such as customers and contact center agents. The interactions and/or the agents of the interactions may be expected to operate in a way that is constructive, that is polite, and/or that meets certain interaction guidelines/rules. An interaction which does not meet a set of expectations (whether those above or otherwise), may be unsatisfactory to the contact center. It may be desired that, when an interaction is unsatisfactory, a supervisor is notified in real time and the supervisor may then carry out a real-time intervention, such as taking over the call.

It may be desired to find systems and methods which automatically monitor interactions in real time to assess whether or not the interactions are satisfactory. It may be desired that an assessment of the interactions be provided to a contact center supervisor.

Existing interaction monitoring systems may raise an alert if a key word or phrase, or a small number of key words or phrases are mentioned in the interaction. There is a need for better monitoring of interactions in real time.

### SUMMARY OF THE INVENTION

Embodiments may improve interaction monitoring technology by monitoring interactions in real time, taking into account of all or substantially all of the interaction, and/or substantially improving the accuracy of interaction monitoring systems. In some embodiments the context in which words or phrases are mentioned is taken into account, and may detect that an interaction is unsatisfactory or otherwise has a low rating earlier in the interaction (e.g., earlier in time) than with prior art systems.

Systems and methods for automatic real-time monitoring of interactions may be carried out by at least one computer processor, the systems and methods including, for example: producing a score for each text component of a text representation of an interaction; producing, based on the score for each text component, a score for each of a plurality of time periods of the interaction; producing a score history, including a plurality of the time period scores; and calculating, based on the score history, a real-time indication of the quality of the interaction.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is a schematic drawing of a system according to some embodiments of the invention.

FIG. 3 depicts a flowchart of methods for monitoring an interaction in real time and providing an indication of the quality of the interaction, according to some embodiments of the present invention.

FIG. 4 depicts a flowchart of methods for monitoring an interaction in real time and providing an indication of the quality of the interaction, according to some embodiments of the present invention.

FIG. 5 depicts a dataflow diagram for monitoring an interaction in real time and providing an indication of the quality of the interaction, according to some embodiments of the present invention.

FIG. 6 depicts the actions of a recommendation engine according to some embodiments of the invention.

FIG. 7 is a data flow diagram of a segmentation module according to some embodiments of the present invention.

FIG. 8 is a data flow diagram of a classification module according to some embodiments of the present invention.

FIG. 9 is a data flow diagram of quality indication module according to some embodiments of the present invention.

FIG. 10 is a data flow diagram describing the training process of machine learning models according to some embodiments of the present invention.

FIG. 11 is a data flow diagram of a calibration module according to some embodiments of the present invention.

FIG. 12 depicts an example of results produced during a calibration process according to some embodiments of the present invention.

FIG. 13 is a data flow diagram describing automatic tagging of unsatisfactory interactions according to embodiments of the present invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

As used herein, “contact center” may refer to a centralized office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers. The company may be a contact-center-as-a-service (CCaaS) company.

As used herein, “call center” may refer to a contact center that primarily handles telephone calls rather than other types of enquiries, communications, or interactions. Any reference to a contact center herein should be taken to be applicable to a call center, and vice versa.

As used herein, “interaction” may refer to a communication between two or more people (e.g., in the context of a contact center, an agent and a customer), and may include, for example, voice telephone calls, conference calls, video recordings, face-to-face interactions (e.g., as recorded by a microphone or video camera), emails, web chats, SMS messages, etc. An interaction may be recorded. An interaction may also refer to the data which is transferred and stored in a computer system recording the interaction, the data representing the interaction, including for example voice or video recordings, metadata describing the interaction or the parties, a text-based transcript of the interaction, etc. Interactions as described herein may be “computer-based interactions”, e.g., one or more voice telephone calls, conference calls, video recordings/streams of an interaction, face-to-face interactions (or recordings thereof), emails, web chats, SMS messages, etc. Interactions may be computer-based if, for example, the interaction has associated metadata stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages. An interaction may take place using text data, e.g., email, web chat, SMS, etc., or an interaction may not be text-based, e.g., voice telephone calls. Non-text-based interactions may be converted into text-based representations (e.g., using automatic speech recognition). Interaction data may be produced. transferred, received, etc., asynchronously. For example, in a voice call, there may be periods of rapid conversation and other periods with no conversation (e.g., when an agent puts the customer on hold).

As used herein, “agent” may refer to a contact center employee that answers incoming interactions, and may, for example, handle customer requests.

As used herein, “supervisor” may refer to a contact center employee that, possibly among other responsibilities, mediates, supervises, or intervenes in contact center interactions. A supervisor may also be known as a dispute manager. In some embodiments, a “supervisor” may not be a person at all, but rather a supervisor computer system. For example, an intervention alert, according to embodiments of the following invention, may be given to either a “supervisor” employee, such that they may choose to intervene in an interaction in accordance with their instructions as an employee, or the alert may be transferred/sent to a “supervisor” computer system, which may decide to intervene in an interaction in accordance with its programming/algorithms.

A used herein, “real-time” or “real time” may refer to systems or methods with an event to system response time on the order of seconds, milliseconds, or microseconds. It may be preferable that the event to system response time is minimized, e.g., it is on the order of milliseconds or microseconds. In the context of the present invention, real-time may relate to a supervisor receiving an alert or indication regarding an interaction being unsatisfactory while the interaction is still in progress, such that the supervisor may take action to improve the interaction. It may be preferable that the alert or indication is given to the supervisor in a short amount of time after the interaction has started to become unsatisfactory. In the following description, it is to be understood that systems and methods that are described as real-time embodiments may be embodiments that are suitable for real-time implementation, but which may additionally be suitable for implementation that is not in real time. For example, recommendation engines of the present invention may be suitable for outputting intervention recommendations in real time (e.g., while the interaction is still ongoing), but may also be given previously recorded interactions and/or give recommendations not in real time.

As used herein, “text representation” may refer to data representing readable characters. A text representation may, for example, be plain text or formatted text. A text representation may be a representation in text of an interaction, wherein the interaction may or may not have originally taken place in text form. For example, an instant message chat form of an interaction may take place in text form, and from a which a text representation may be easily extracted. By way of a different example, a telephone call form of an interaction would not take place in text form, and a text representation may need to be extracted/obtained using, for example, speech recognition systems or software.

As used herein, “text component” may refer to a word, a phrase, a clause, or similar in a text data format. In some embodiments, a text component may refer only to words. A text component may be recognized from text data, by, for example, speech recognition systems or software.

As used herein, “time period” may refer to a period of time during an interaction. An interaction may include multiple standardized time periods of a certain length (e.g., it may be possible to break an interaction up into multiple 10 second time periods). One time period may correspond to a number of text components, e.g., one time period may contain 8 text components, and another time period may contain no text components.

As used herein, “score” or “interaction score” may refer to a value given to some portion of an interaction (e.g., one or more text components, or one or more time periods) to indicate a perceived quality or satisfaction with the portion of the interaction, and/or with the agent during the interaction. The score may be obtained using a dedicated engine, which may use machine learning algorithms. The score may be given/stored as a category, for example, in one embodiment, the score may be given as “acceptable” or “unacceptable”. In another embodiment, the score may be given as “low”, “medium”, or “high”. In a further embodiment, a score may be given as a number, for example, an integer between 1 and 10 (with, typically, higher scores indicating better quality, although the reverse may be used), or a floating-point number between 0 and 1. In each example, there may be a limit or cutoff, wherein a particular score may have a value (e.g., “low”) or one of a group of values (e.g., 1_“score”≤3) which are deemed to be unsatisfactory. A score may be produced for each text component, either taking the text component as an input, or taking the text component as well as a number of previous text components as an input. A score may additionally or alternatively be produced for a time period, wherein a number of text components may be associated with the time period (e.g., a time period may be 10 seconds and 7 text components may be associated with this time period). Multiple recently calculated scores may be grouped into a score history or collection. In much of the description that follows, scores will be discussed as numbers, but this should not be understood as limiting.

As used herein, a “real-time indication of the interaction quality”, “interaction quality”, or similar, may refer to any indication (e.g., in the form of an electric signal) which may be capable of being produced in real time with respect to the interaction (even if the interaction in question has, in fact, already happened), which may indicate an interaction quality, e.g., whether the interaction is satisfactory or unsatisfactory. The real-time indication may be an alert, e.g., to alert a contact center supervisor (e.g., via a display on a screen) about an unsatisfactory interaction. Additionally or alternatively, the real-time indication may be an updating interaction score. The real-time indication may be displayed/conveyed to a user (e.g., a supervisor) through a computational output device. For example, the real-time indication may be displayed using a monitor and further using a user interface (e.g., graphical user interface), which may display the real-time indication in any suitable way.

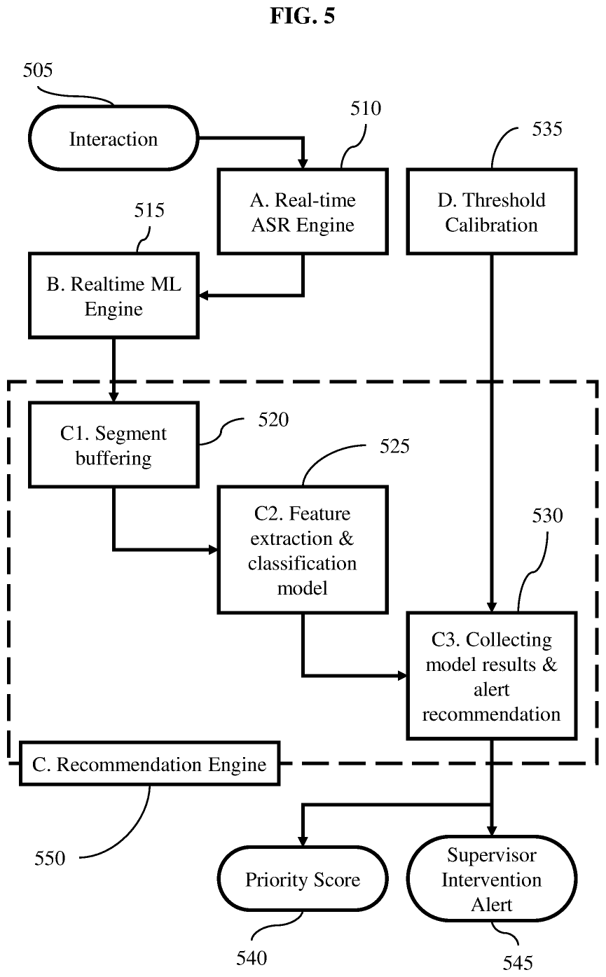

As used herein, “alert” may refer to any event, for example, carried out by a computer device, that notifies, warns, or informs a supervisor that an interaction is (or may be) unsatisfactory. The alert may indicate that the interaction may require some form of intervention. Whether or not an alert is required may be stored as a Boolean variable (e.g., True or False) which may be computationally transferred (e.g., from module C3 of FIGS. 5, 6, and 9 to another module/engine/algorithm).

As used herein, “updating interaction score” or “priority score” may refer to a real-time output score indicative of the quality of an interaction. A priority score may be used to view how a quality of an interaction changes over time.

As used herein, “array”, “buffer”, “vector”, “byte array”, or similar, may refer to a data structure that holds a collection of values and/or variables. Each value/variable in an array may be identified by an index number. An array may, for example, store a number of values (e.g., scores) received from a computer module/algorithm.

As used herein, “module” may refer to a computer algorithm or a piece of computer software that may provide a specific functionality within overall systems or methods (e.g., segmentation module, classification module, etc.). In some embodiments, a module may be packaged as a software library. In some embodiments herein, “engine” may have a somewhat similar meaning to module, and may be configured to provide specific functionality within overall systems or methods.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms. In a supervised ML approach, input sample data may include data which is labeled, for example, in the present application, the input sample data may include a transcript of an interaction and a label indicating whether or not the interaction was satisfactory. In an unsupervised ML approach, the input sample data may not include any labels, for example, in the present application, the input sample data may include interaction transcripts only.

ML models used herein may, for example, include (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random Forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

In practice, a NN, or NN learning, can be simulated by one or more computing nodes or cores, such as generic central processing units (CPUs, e.g., as embodied in personal computers) or graphics processing units (GPUs such as provided by Nvidia Corporation), which can be connected by a data network. A NN can be modelled as an abstract mathematical object and translated physically to CPU or GPU as, for example, a sequence of matrix operations where entries in the matrix represent neurons (e.g., artificial neurons connected by edges or links), and matrix functions represent functions of the NN.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores. Decision trees may refer to a data structure or algorithm including, or capable of representing, a series of linked nodes. Decision trees may be used for classification of a data instance/object into a certain class by interrogating features of the instance/object. The linked nodes may include a root node, at least one leaf node (or terminal node), and likely one or more internal nodes, wherein the root node may be connected to a plurality of child nodes (internal or leaf), the internal nodes may be connected to one parent node (internal or root) and a plurality of child nodes, and the leaf node may be connected to one parent node. To classify an object/instance with a decision tree, it may be traversed, wherein traversal begins at the root node. Each root node or internal node may interrogate a feature of the object in a way that categorizes the object into one of a plurality of categories (often two categories corresponding to two child nodes). Each of these categories may be associated with one of the plurality of connected child nodes, and when an object is found to be in one of the categories, the traversal of the decision tree may move to the associated child node. This process may continue until the presently considered node of the traversal is a leaf node. Each leaf node may be associated with a class or classification of the object (e.g., satisfactory or unsatisfactory) and may not further interrogate features of the object. In some embodiments, decision trees may be implemented with object-oriented programming. In some embodiments, a decision tree may be constructed based on existing/past data (e.g., existing interaction and/or score data, which may also be associated with an indication of whether the interaction was satisfactory). Construction of a decision tree may be configured to maximize/minimize a metric, such as constructing a decision tree so as to maximize an information gain metric. In some embodiments, the features that are most important for categorization may be higher up or closer to the beginning/root of the tree, and features that are less important may be further from the root.

It will be understood that any subsequent reference to “machine learning”, “machine learning algorithms”, “machine learning models”, “ML”, or similar, may refer to any/all of the ML examples herein, as well as any other ML models and methods as may be considered appropriate.

In all discussion of “scores”, “factors”, “thresholds”, “probabilities”, or similar, in this application, it will be appreciated that discussion of “high” or “low”, “positive” or “negative”, “probable” or “improbable”, may represent one specific embodiment, wherein other variations may be directly derivable (e.g., it may be somewhat arbitrary whether some factor is described as being positive or negative).

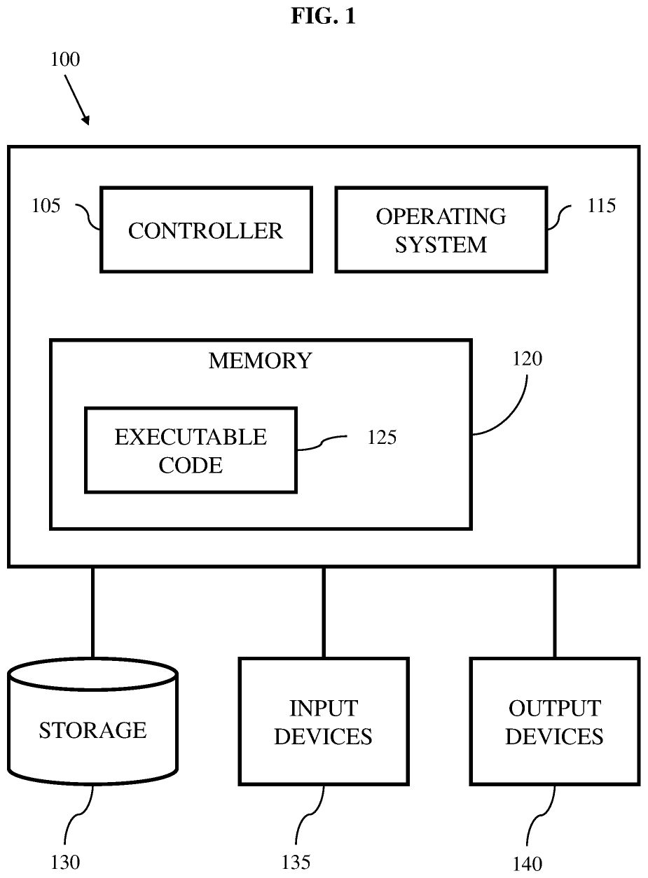

FIG. 1 shows a block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

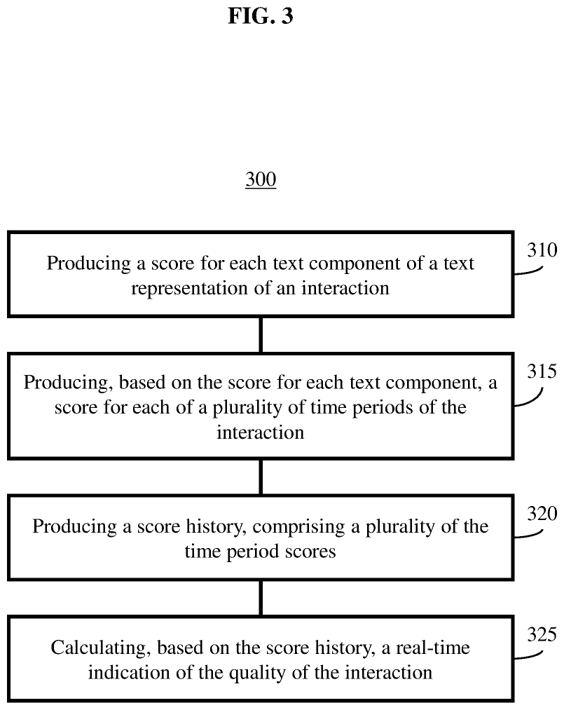

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. At least a portion of Memory 120 may include data storage housed online on the cloud. Memory 120 may be or may include a plurality of different memory units. Memory 120 may store, for example, instructions (e.g., code 125) to carry out methods as disclosed herein, for example, the methods of FIGS. 3-11. Memory 120 may use a datastore, such as a database.

Executable code 125 may be any application, program, process, task, or script. Executable code 125 may be executed by controller 105 possibly under control of operating system 115. For example, executable code 125 may be, or may execute, one or more applications performing methods as disclosed herein, such as monitoring interactions in real time. In some embodiments, more than one computing device 100 or components of device 100 may be used. One or more processor(s) 105 may be configured to carry out embodiments of the present invention by, for example, executing software or code.

Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105. Storage 130 may include cloud storage.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g., memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

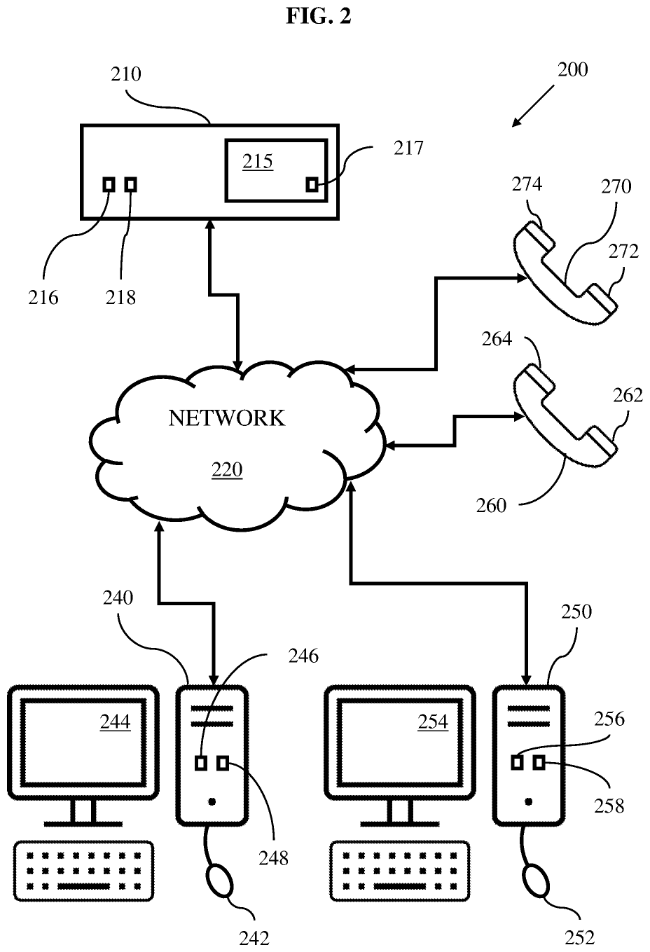

FIG. 2 is a schematic drawing of a system 200 according to some embodiments of the invention. System 200 may include one or more server(s) 210, database(s) 215, telephones 260, 270, . . . , etc., and/or computer(s) 240, 250, . . . , etc., each of which may be or include computers (e.g., computer 100) or components, such as shown in FIG. 1. Any or all of system 200 devices may be connected via one or more network(s) 220. Network 220, which connects server(s) 210, computers 240 and 250, and/or telephones 260 and 270 may be any public or private network such as the Internet. Access to network 220 may be through wire line, terrestrial wireless, satellite, or other systems well known in the art.

Server(s) 210 and computers 240 and 250, may include one or more controller(s) or processor(s) 216, 246, and 256, respectively, for executing operations according to embodiments of the invention and one or more memory unit(s) 218, 248, and 258, respectively, for storing data (e.g., interactions, scores, etc., according to embodiments of the invention) and/or instructions (e.g., methods for assessing the quality of an interaction in real time according to embodiments of the invention) executable by the processor(s). Processor(s) 216, 246, and/or 256 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 218, 248, and/or 258 may include, for example, a random-access memory (RAM), a dynamic RAM (DRAM), a flash memory, a volatile memory, a non-volatile memory, a cache memory, a buffer, a short-term memory unit, a long-term memory unit, or other suitable memory units or storage units.

Computers 240 and 250 may be servers, personal computers, desktop computers, mobile computers, laptop computers, and notebook computers or any other suitable device such as a cellular telephone, personal digital assistant (PDA), video game console, etc., and may include wired or wireless connections or modems. Computers 240 and 250 may include one or more input devices 242 and 252, respectively, for receiving input from a user (e.g., via a pointing device, click-wheel or mouse, keys, touch screen, recorder/microphone, or other input components). Computers 240 and 250 may include one or more output devices 244 and 254 (e.g., a monitor, screen, or speaker) for displaying or conveying data to a user provided by or for server(s) 210.

Telephones 260 and 270 may be traditional telephones (e.g., landline telephones), and/or may be part of or in operation with one or more computers (e.g., smart phones and contact center phone systems), e.g., using voice over IP (VOIP) telephony. Telephones 260 and 270 may include one or more input components 262 and 272, respectively, for receiving input from a user (e.g., via a recorder/microphone, touch screen, or other input components). Telephones 260 and 270 may include one or more output devices 264 and 274 (e.g., a speaker, monitor, or screen) for conveying or displaying data (e.g., audio data from another telephone) to a user provided by or for server(s) 210.

In some embodiments, a first computer or telephone (e.g., 240 or 260) may be associated with a contact center and/or used by an agent, and a second computer or telephone (e.g., 250 or 270) may be associated with or used by a customer. Each computer or telephone may record an input (e.g., sound of a conversation) and may transfer data indicative of this input to the network 220. Each computer or telephone may receive data indicative of an input from the network, possibly via a server 210, and may then output this data (e.g., data indictive of sound may be output using a speaker). The server 210 and/or the network 220 may additionally be associated with or operated by the contact center.

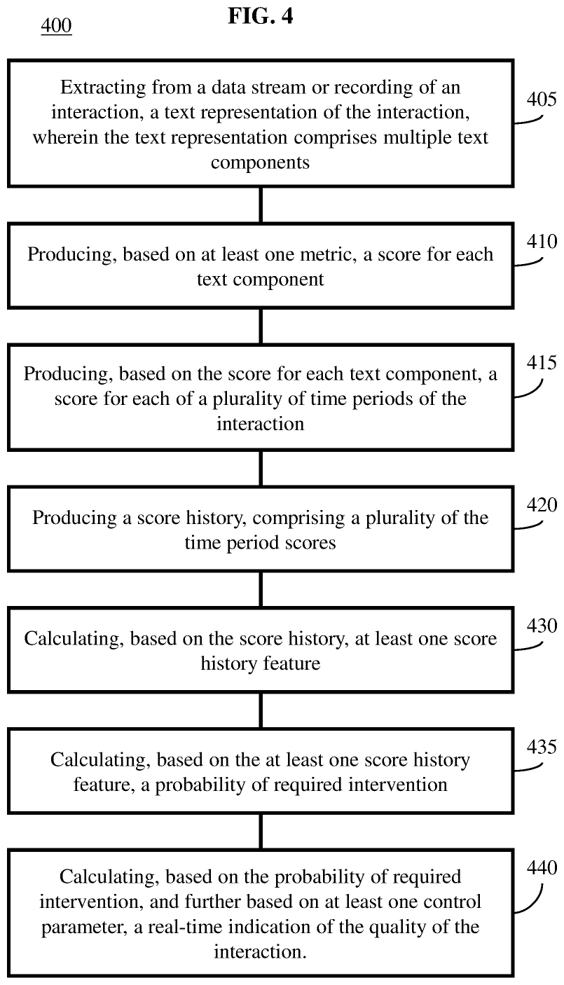

For example, an agent may ask a question into the microphone of an agent telephone, data representing this recorded sound may be transferred via a network and a server to a customer telephone, and the sound may then be output via the speaker of a customer telephone. The server, the agent computer, and/or the agent telephone may use a recording of the interaction as an input. For example, operation 405 of FIG. 4 may receive a data stream or recording of an interaction from the server, which data representing the interaction is transferred through. Embodiments may then be carried out by the server, or another connected computational device, based on this data (e.g., operations 405-440 of FIG. 4 may be carried out on server 210).

Any computing devices of FIGS. 1 and 2 (e.g., 100, 210, 240, and 250), or their constituent parts, may be configured to carry out any of the methods of the present invention.

Any computing devices of FIGS. 1 and 2, or their constituent parts, may include a recommendation engine, or another engine or module, which may be configured to perform some or all of the methods of the present invention. The systems and methods of the present invention may be incorporated into or form part of a larger platform or a system/ecosystem, such as customer relationship management (CRM) platforms or management platforms. The platform, system, or ecosystem may be run using the computing devices of FIGS. 1 and 2, or their constituent parts.

FIG. 3 depicts a flowchart of a method 300 for monitoring an interaction in real time and providing an indication of the quality of the interaction. According to some embodiments, some or all of the steps of the method are performed (fully or partially) by one or more of the computational components, for example, those shown in FIGS. 1 and 2.

In operation 310, a score may be produced for each text component of a text representation of an interaction. Alternatively, operation 310 may involve producing a score for each text component and some number of previous text components that have already been received. For example, in operation 310, a score may be produced for all received/known text components, including the most recently received text component. By way of another example, in operation 310, a score may be produced for a number (e.g., 10 or 20) of recently received text components, including the most recently received text component. Such an operation may be run in real time, such that, when new text components are being received in real time, operation 310 is run for each new text component that is received. This operation may be carried out by a dedicated engine, e.g., a scoring engine. This operation may additionally or alternatively use ML models to score a text component. ML scoring models may be constructed to place importance on various different factors. For example, some scoring models may be constructed to emphasize that an interaction is unsatisfactory if the language shows signs of anger (e.g., swearing/cursing, forceful language, etc.). In other examples, scoring models may be constructed to place emphasis on language that specifically recites concerns with the interaction (e.g., “I'm disappointed”, “I'd like to speak with your manager”, etc.). Operation 310 may correspond (fully or partially) with a scoring module (e.g., B), e.g., as discussed in FIG. 5.

Operation 310 may additionally or alternatively receive other input data, for example, audio data from the interaction and/or specific features of the audio data (where the interaction is an audio-based interaction), or video data and/or specific features of the video data (where the interaction is a video-based interaction). For example, operation 310 may receive indications of amplitude/volume levels during an interaction (or during utterance of the relevant text component), and/or frequency/pitch levels during the interaction (or during utterance of the relevant text component). This other input data may additionally or alternatively be used to produce scores for each text component. In some examples, scoring models may be constructed to place emphasis on tone or volume of voice, that may, for example, indicate anger (e.g., raised voices, raised pitch).

In some embodiments, multiple scores may be produced in operation 310, for example, by multiple ML models and potentially prioritizing different concerns, e.g., one concerned with language and one with voice tone. In this example, the next operation may be given, for example, an average of the scores, or the lowest/most concerning score, etc. Any selection, averaging, or calculations which may be required to convert multiple scores into one score may fall under the meaning of producing a score within the meaning of operation 310.

In operation 315, a score for each of a plurality of time periods of the interaction may be produced, based on the score for each text component. Operation 315 may involve converting a number (e.g., 0, 1, 6, etc.) of text component scores (corresponding to the same number of text components) into a time period score. Operation 315 may be performed, for example, by a segmentation module (e.g., C1), e.g., as discussed with respect to FIGS. 5-7. Each text component score produced during a time period may be stored in a buffer. At the end of each time period, a time period score may be calculated based on the scores in the buffer. If no scores were produced in the time period (e.g., no words were spoken during the time period), then there may be no scores in the buffer. In this case, the time period score may be calculated based on a previous score (e.g., the new time period score may be the same as the previous time period score). The time period may be any suitable length of time (e.g., 1 second, 10 seconds, etc.). It may be preferable that the time period is a length of time in which typically a small number (e.g., less than 10) of text components are likely to have been received/sent/said.

In an example where each text component score is based on the newest (e.g. produced most recently in time) text component as well as all (or a large number of) preceding (e.g. earlier in time or sequence) text components, the time period score for the time period may simply be/use the latest score stored in the buffer (and disregard any earlier scores). In a different example, where each text component score is based only on the new text component (or the new text component and a small number of preceding text components), the time period score may be taken as an average (e.g., mean or median) of the scores stored in the buffer. Alternatively, in either case, the other score calculation method may be used.

Once the time period score is calculated for a time period, or at the end of a time period, the buffer may be cleared/emptied of all text component scores, such that the process may repeat for the next time period (and newly received text components).

In operation 320, a score history may be produced, including a plurality of the time period scores. A score history may include a number of the most recently calculated time period scores (e.g., the score history may include the 10 most recently produced time period scores, or the scores for the 10 time periods occurring most recently). Additionally or alternatively, the score history may include calculated time period scores corresponding to a longer time period (e.g., 60 seconds, 100 seconds, 120 seconds, etc.). A score history may be stored, for example, as an array. Operation 320 may involve a segmentation module (e.g., C1), e.g., as discussed with respect to FIGS. 5-7.

In operation 325, a real-time indication of the quality of the interaction may be calculated based on the score history. Operation 325 may in some embodiments be carried out as one process, by, for example, one ML model. In other embodiments, operation 325 may be split into a plurality of separate processes (e.g., a classification module and a quality indication module), for example, as described with respect to FIGS. 4-9. Operation 325 may use at least one ML model or algorithm to calculate, based on the updating score history, a real-time indication as to the interaction quality, e.g., whether the interaction is currently satisfactory. Training (and/or testing) datasets for such an ML model may include score histories of previous interactions. These datasets may be labelled, e.g., it may be known whether the previous interactions were satisfactory or unsatisfactory (e.g., based on the assessment of a supervisor), and, where they are unsatisfactory, it may be known at what stage/time of the interaction (or element of the score history), the interaction became unsatisfactory. Therefore, based on at least the history of scores, an ML model may output a real-time indication of the quality of the interaction.

A real-time indication may include a warning or alert when the quality of the interaction falls below some threshold. In response to receiving such a warning or alert, the receiver, e.g., a supervisor, may wish to intervene (e.g., by joining the interaction) in the ongoing interaction, e.g., to move the interaction in a more satisfactory direction. Supervisor interventions may include, for example, (actively) monitoring the interaction, privately messaging the contact center agent, joining the interaction, taking over the interaction, terminating the interaction, etc. Operation 325 may include sending the real-time indication to another computational device. Operation 325 may additionally be calculated based on the time since the beginning of the interaction. For example, it may be that an increase in terse/angry language a substantial length of time into an interaction (e.g., when a customer issue should ideally be being solved) may be treated as more serious/less satisfactory than terse/angry language near the beginning of an interaction (e.g., when a customer has been on hold for a period of time). In some embodiments, operation 325 may include the steps of obtaining at least one score history feature or characteristic from the live score history, and obtaining an indication of a probability that interaction intervention is required based on the at least one score history feature or characteristic. Operation 325 may additionally be based on other features, for example, the passed since the beginning of the interaction, or experience or skills of the relevant agent (e.g., it may be known that the agent is relatively new, and as such, may be more likely to require intervention and the real-time indication of the quality of the interaction may take this into account). Operation 325 may additionally comprise the step of outputting the probability that interaction intervention is required using a computer output device.

FIG. 4 depicts a flowchart of a method 400 for monitoring an interaction in real time and providing an indication of the quality of the interaction. According to some embodiments, some or all of the steps of the method are performed (fully or partially) by one or more of the computational components, for example, those shown in FIGS. 1 and 2. Method 400 may represent an example method, including various optional features not present in method 300. Method 400 may represent a particular embodiment of method 300. In some embodiments, some or all of the features of method 400 may be incorporated into method 300. For example, step 405 could be incorporated at the start of method 300 (e.g., if required).

In operation 405, a text representation of an interaction may be extracted or generated from a data stream or recording of the interaction, wherein the text representation may include multiple text components. The interaction may continue to take place while the rest of the operations take place. Data may be captured of the interaction. For example, where the interaction is a voice call or similar, this interaction may be recorded with a microphone (e.g., via input devices of computers 240 and 250, telephones 260 and 270, or a combination thereof), and the recorded interaction may be encoded as an audio file/data stream (e.g., in the WAV data format). Where the interaction is text-based, e.g., email, web chat, SMS, etc., a text-based recording of the interaction may be extracted directly from where the interaction is stored, e.g., as a text file/data stream. Since the operations are configured to operate in real-time with the interaction, the recording of the interaction may be configured to be transferred as a real-time data stream. In operation 405, a text representation of the interaction may be extracted/calculated from the ongoing (real-time) interaction or a recording thereof. Operation 405 or its actions may be performed by module or engine A, or suitable text extraction module/engine. Operation 405 may, in the example where an interaction is a voice call or similar, involve an automatic speech recognition (ASR) engine, algorithm or software. ASR may be configured to receive audio data (e.g., as a WAV file/fragment) and extract or calculate from this data, words or text components of any human speech that may be audible in the data. Operation 405 may include inputting a sound-based representation of the interaction, e.g., an audio recording, into a speech-to-text algorithm. The words that are detected may be stored as text data (e.g., an updating.txt file). Any suitable ASR engine may be used. For example, an ASR engine may be constructed as an ML model, which may be trained, for example, with training data of audio files, which may be labelled with a transcript of the words that are spoken in the file. Operation 405 may not be required/necessary, or may be much simpler, if the recording of the interaction is already in text form. For example, operation 405 may be straightforward if the interaction is an online message chat and may simply involve copying and/or transferring text.

In operation 410, a score may be produced for each text component based on at least one metric. Operation 410 may evaluate each of a plurality of text components of the text representation to produce a score for each text component. In operation 410, a score may be produced for each text component of a text representation of an interaction. Alternatively, operation 410 may involve producing a score for each text component and a number of previous text components that have already been received. For example, in operation 410, a score may be produced for all received/known text components for a certain interaction, including the most recently received text component. By way of another example, in operation 410, a score may be produced for/based on a number (e.g., 10 or 20) of recently received text components, including the most recently received text component. Regardless, this operation may be run in real time, such that, when new text components are being received in real time, operation 410 is run for each new text component that is received. This operation may be carried out by a dedicated engine, e.g., a scoring engine. Text components of an interaction may be input into the engine, and a score for each text component may be received from the engine. This operation may additionally or alternatively use ML models to score a text component. ML scoring models may be constructed to place importance on various different factors or metrics. For example, some scoring models may be constructed to emphasize that an interaction is unsatisfactory if the language shows signs of anger (e.g., swearing/cursing, forceful language, etc.). In other examples, scoring models may be constructed to place emphasis on language that specifically recites concerns with the interaction (e.g., “I'm disappointed”, “I'd like to speak with your manager”, etc.). Operation 410 may correspond (fully or partially) with a scoring module or module B. e.g., as discussed in FIG. 5. Scores may be produced by a real-time interaction guidance (RTIG) system.

Operation 410 may additionally or alternatively receive other input data, for example, audio data from the interaction and/or specific features of the audio data (where the interaction is an audio-based interaction), or video data from the interaction and/or specific features of the video data (where the interaction is a video-based interaction). For example, operation 410 may receive indications of amplitude/volume levels during an interaction (or during utterance of the relevant text component), and/or frequency/pitch levels during the interaction (or during utterance of the relevant text component). This other input data may additionally or alternatively be used to produce scores for each text component. In some examples, scoring models may be constructed to place emphasis on tone, volume of voice, or body language, that may, for example, indicate anger (e.g., raised voices, raised pitch, gesticulating).

In some embodiments, multiple scores may be produced in operation 410, for example, by multiple ML models and potentially prioritizing different concerns, e.g., one concerned with language and one with voice tone. In this example, the next operation may be given, for example, an average of the scores, or the lowest/most concerning score, etc. Any selection, averaging, or calculations which may be required to convert multiple scores into one score may fall under the meaning of producing a score within the meaning of operation 410.

Operation 410 may be based on at least one metric or factor (e.g., as discussed herein). Metrics may include any measure which guides how a score may be calculated. Metrics may relate to interaction sentiment or interaction behaviors. Metrics may additionally or alternatively relate to the examples discussed herein of: signs of anger, concerned language, and tone or volume of voice. In one basic example, a metric may define that a given score should be low if there are two or more incidences of signs of angry sentiment in the language of the interaction.

In some embodiments operation 410 may include inputting a text representation of an interaction and at least one scoring metric into a scoring engine or algorithm. Alternatively, the metric may be used to construct the scoring engine or algorithm that the at least one text representation of the interaction may be input into. The scoring metric may comprise at least one of a customer sentiment (e.g., is the customer satisfied with the interaction, or is the language or voice of the customer positive or negative) and an agent behavior. Agent behavior may be assessed based on, for example, whether the agent is reassuring the customer that they understand the issue and are able to help, whether the agent is actively responding in the conversation, how often the agent is asking the customer to repeat themselves, whether the agent is attempting to build a personal connection or rapport with the customer, whether the agent is summarizing actions and next steps and informing the customer what to expect, whether the agent is polite and thankful, and whether the language or tone of voice of the agent is positive. Each of customer sentiment and agent behavior may be used as a customer metric when training an ML model or algorithm, e.g., as discussed herein.

In operation 415, a score for each of a plurality of time periods of the interaction may be produced, based on the score for each text component. Operation 415 may convert the score for each text component into a score for each time period of a plurality of time periods of the interaction. Operation 415 may involve converting a number (e.g., 0, 1, 6, etc.) of text component scores (corresponding to the same number of text components) into a time period score. Operation 415 may involve a segmentation module (e.g., C1), as discussed with respect to FIGS. 5-7. Each text component score produced during a time period may be stored in a buffer. At the end of each time period, a time period score may be calculated based on the scores in the buffer, or if no scores exist in the buffer, the most recent previous score may be used. The time period may be any suitable length of time (e.g., 1 second, 10 seconds, etc.). It may be preferable that the time period is a length of time in which typically a small number (e.g., less than 10) of text components are likely to have been received/sent/said.

In an example where each text component score is based on the newest text component as well as all (or a large number of) preceding text components, the time period score for the time period may simply be/use the latest score stored in the buffer (and disregard any earlier scores).

In a different example, where each text component score is based only on the new text component (or the new text component and a small number of preceding text components, e.g., those earlier in time or sequence), the time period score may be taken as an average (e.g., mean or median) of the scores stored in the buffer.

Once the time period score is calculated for a time period, or at the end of a time period. the buffer may be cleared/emptied of all text component scores, such that the process may repeat for the next time period (and newly received text components).

In operation 420, a score history may be produced; for example, a score history may include a plurality of the time period scores. Operation 420 may group or buffer a plurality of the most recent (e.g., most recently created, associated with the most recent X time periods, where X is an integer) time period scores into a live score history. A score history may be a set or list including recent time period scores, e.g., a score history may include a number of the most recently calculated time period scores (e.g., the score history may include the 10 most recent time period scores). Additionally or alternatively, the score history may include calculated time period scores corresponding to a longer time period (e.g., 60 seconds, 100 seconds, 120 seconds, etc.). A score history may be stored, for example, as an array. Operation 320 may involve a segmentation module (e.g., C1), e.g., as discussed with respect to FIGS. 5-7.

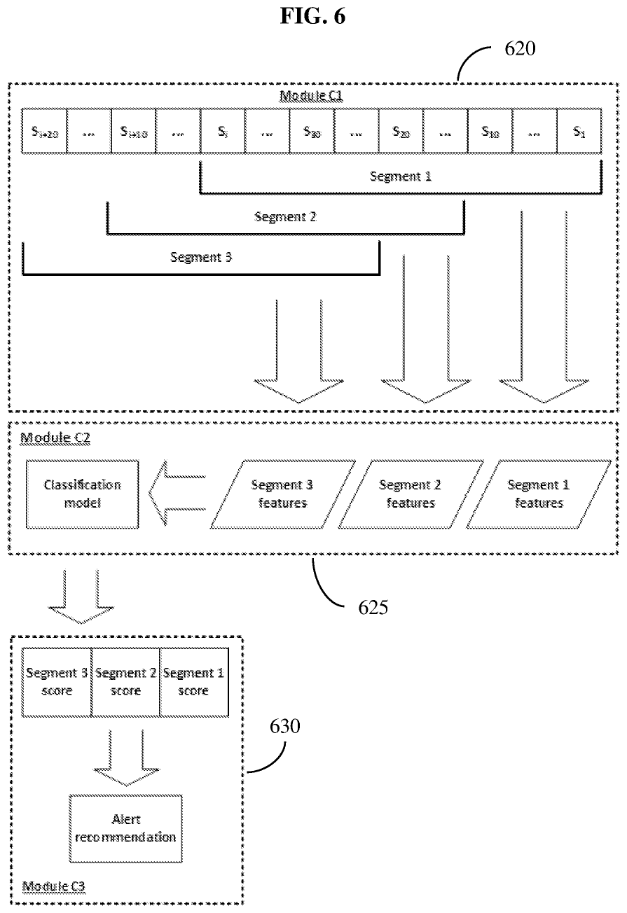

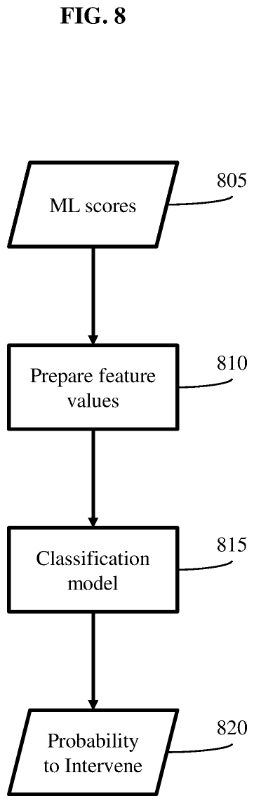

In operation 430, at least one score history feature or score history characteristic may be calculated based on the score history. For example, a mathematical derivation or description of the set of scores in the score history may be calculated as the score history characteristic, such as the minimum score in the score history, the average of the scores in the score history, etc. Operation 430 may be described as obtaining at least one score history characteristic from the live score history. Operation 430 may in some embodiments form a component part of operation 325. Operation 430 may in some embodiments correspond to at least a portion of a classification module, e.g., module C2 of FIG. 6 and/or the flowchart of FIG. 8. Operation 430 may accept, receive, or use a score history with one or more scores. One or more features or characteristics (e.g., score history features) may be calculated from the score history. Examples of features (e.g., score history features) may include the following (others may be used):
“min”—the lowest score in the score history/buffer.
“max”—the highest score in the score history/buffer,.
“mean”—the mean average of the scores in the score history/buffer,.
“median”—the median average of the scores in the score history/buffer,.
“diff”—the difference between the highest and the lowest scores in the score history/buffer,.
“trend”—the difference between the mean average (or other average) of the second and the first halves of the score history/buffer,
· a list of raw scores.

In operation 435, a probability of required intervention may be calculated based on the at least one score history feature. Operation 435 may additionally be based on other features, for example, experience or skills of the relevant agent (e.g., it may be known that the agent is relatively new, and as such, may be more likely to require intervention), or an “offset” or time elapsed since the beginning of a interaction/call (e.g., negative scores later in an interaction may be more concerning). Operation 435 may in some embodiments form a component part of operation 325. Operation 435 may in some embodiments correspond to at least a portion of a classification module, e.g., module C2 of FIG. 6 and/or the flowchart of FIG. 8. The probability of required intervention may not in some embodiments correspond to an actual probability that intervention actually takes place or is deemed necessary by the contact center. The probability of required intervention may additionally or alternatively be known as an intervention likelihood factor, or simply an intervention factor. The probability of required intervention may be calculated using an ML model. The ML model may have been trained with one or more score history features (as training data). Training data may have been labeled with a likelihood that intervention is required for each input set of history feature values. For example, one piece of training data may indicate that, if there is a strong negative “trend” (e.g., the scores are dropping rapidly), this may indicate a high probability that intervention is required.

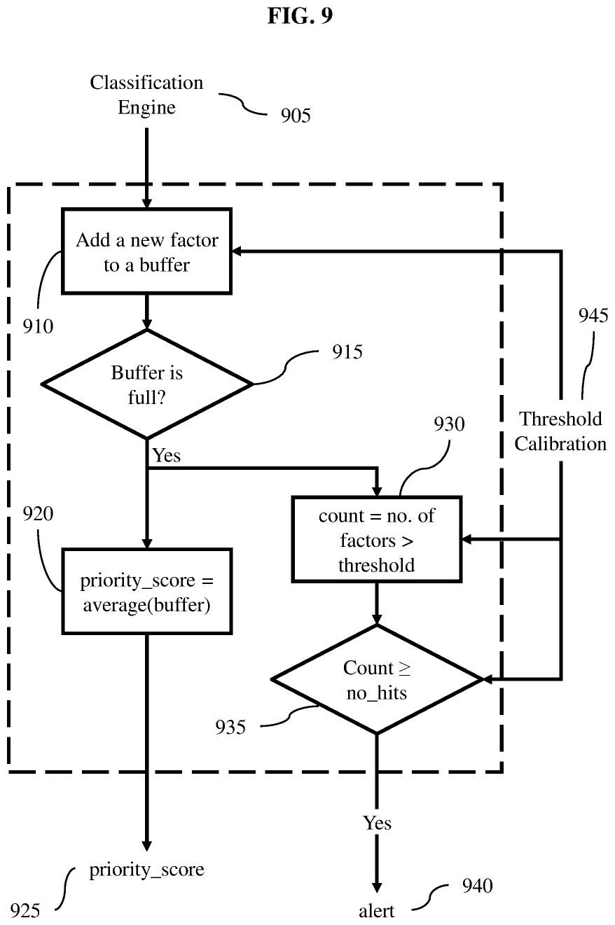

In operation 440, a real-time indication of the quality of the interaction may be calculated, based on the probability of required intervention, and based on at least one control parameter. A control parameter may be a control heuristic, calibration factor, threshold condition, or similar. Operation 440 may additionally or alternatively include outputting (or displaying, transmitting, etc.) the real-time indication of the quality of the interaction. Operation 440 may in some embodiments form a component part of operation 325. Operation 440 may in some embodiments correspond to a quality indication module, e.g., module C3 (or a portion thereof) of FIG. 6 and/or to FIG. 9. Operation 440 may additionally/alternatively be based on a number of probabilities of required intervention, e.g., the previous three values. In this embodiment, operation 440 may only run once every three time periods, by way of an example. The at least one control parameter may control whether or how the real-time indication of the quality of the interaction is outputted. The at least one control parameter may include for example: a probability/likelihood threshold, a number of consecutive probabilities/likelihoods to be stored for analysis (e.g., the size of the buffer in FIG. 9), and/or a number of hits/above-threshold scores, which may specify how many (e.g., number of hits) of the probabilities/likelihoods stored for analysis (number stored for analysis) are required to be above the threshold (probability threshold) for e.g., an alert to be raised. In other embodiments only a threshold is used (e.g., buffer size=number of hits=1).

In some embodiments, operations 435 and 440 may be performed or described as one step, or they may be carried out by one module. This step may include obtaining an indication of a probability that interaction intervention is required (or a real-time indication of the quality of the interaction) based on the at least one score history characteristic (or feature).

The real-time indication of the quality of the interaction may, for example, be an alert. The alert may be triggered or output if the conditions of the control parameter(s) are met. The real-time indication of the quality of the interaction may be an output score. This output score may be output if the conditions of the control parameter(s) are met (e.g., a threshold of a control parameter is met or exceeded), or alternatively, the score may be output every time a new score is received/every iteration. Operation 440 may additionally include the step of outputting the probability that interaction intervention is required using a computer output device.

FIG. 5 depicts a dataflow diagram for monitoring an interaction in real time and providing an indication of the quality of the interaction. According to some embodiments, some or all of the steps of the method/system are performed (fully or partially) by one or more computational components, for example, those shown in FIGS. 1 and 2.

In operation 505, an interaction may take place, for example, an interaction through a contact center. The interaction may continue to take place while the rest of the operations of the dataflow diagram of FIG. 5 take place. Data may be captured describing the interaction. For example, where the interaction is a voice call or similar, this interaction may be recorded with a microphone, and the recorded interaction may be encoded as an audio file or data stream (e.g., in the WAV data format). Where the interaction is text-based, e.g., email, web chat, SMS, etc., a text-based recording of the interaction may be extracted directly from where the interaction is stored, e.g., as a text file/data stream. The recording or data stream of the interaction, whatever way it is encoded as data (and optionally other information/metadata about the interaction, e.g., volume levels) may be sent or transferred from operation 505 to module A of operation 510 (or may pass directly to module B of operation 515, e.g., where the interaction is text-based). Since the operations are configured to operate in real-time with the interaction, the recording of the interaction may be configured to be transferred to the next operation as a real-time data stream.

In operation 510, a text representation of the interaction may be extracted or calculated from the ongoing (e.g., real-time) interaction or a recording thereof. Operation 510 or its actions may be performed by module/engine A or a suitable text extraction engine. Operation 510 may, in the example where an interaction is a voice call or similar, involve an automatic speech recognition (ASR) engine, algorithm or software. ASR may be configured to receive audio data (e.g., as a WAV file/fragment) and extract or calculate from this data, words or text components of any human speech that may be audible in the data. The words that are detected may be stored in text data (e.g., an updating.txt file). Any suitable ASR engine may be used. For example, an ASR engine may be constructed as an ML model, which may be trained, for example, with training data of audio files, which may be labelled with a transcript of the words that are spoken in the file. Operation 510 may not be required/necessary if the recording of the interaction is already in text form, e.g., an online message chat. The text-based representation of the interaction (and optionally other information/metadata about the interaction) may be passed from module A of operation 510 to module B of operation 515. Data may be transferred as a real-time data stream.

In operation 515, a score may be produced for each component (e.g., each new word) of the text-based representation of the interaction that operation 515 receives. For example, a score may be produced for each text component of an interaction. Scores may be produced in real-time when operation 515 receives a new text-based component. Operation 515 or its actions may be performed by module/engine B or a suitable scoring engine. Module B may be implemented with one or more ML models/engines. The score may be stored as a number (e.g., a floating-point number data type). Operation 515 may output/transfer a score for each text component it received. Data may be transferred as a real-time data stream. The scores may be sent/transferred in real time (e.g., shortly after they are calculated) from module B of operation 515 to module C1 of operation 520.

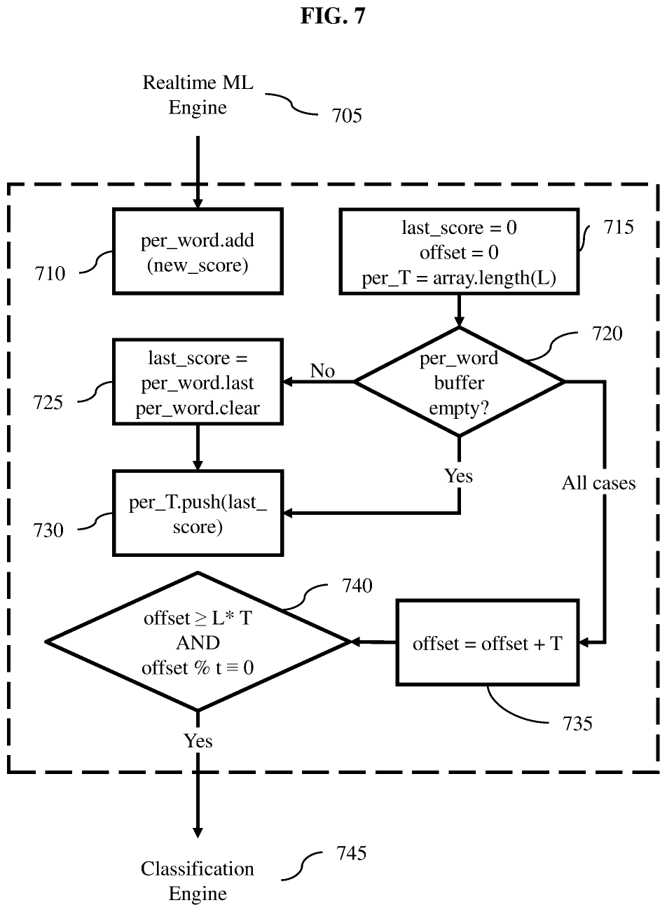

In operation 520, a score for each of multiple text components may be converted into a score for each standardized period of time. Operation 520 or its actions may be performed by a module, engine, or sub-module C1 (e.g., as described in FIG. 7), or a suitable segmentation engine. Module C1 may perform a segmentation process (e.g., it may divide the scores of the interaction into regular length parts). Module C1 of operation 520 may form a component part of module C of operation 550. One embodiment of module C1 is described with respect to FIG. 7. The text component scores may be produced or received irregularly or asynchronously in time, e.g., sometimes speech or instant messages may be rapid and sometimes there may be pauses in communication. It may be desirable for subsequent steps (e.g., modules C2 and C3) that scores are received at a regular/predictable rate in time. Therefore, module C1 may ensure that scores are output at a constant frequency. This may be achieved by module C1 including at least a data buffer (e.g., in computer memory) and a timer (e.g., as implemented by a computer processor). The timer may be configured to repeatedly count to a time period length (e.g., 10 seconds). The buffer may be configured to receive all scores input into C1 (e.g., during the time period). At the end of a time period, the scores contained in the buffer may be used to output an overall score for the time period (a time period score). The time period score may be chosen as the last score received in the buffer. Alternatively, the time period score may be an average (e.g., mean or median) of the scores in the buffer. If the buffer is empty at the end of the time period, the time period score that is output may be copied from the previous time period, or alternatively a null value may be output. The buffer may then (e.g., at the end of the time period) be emptied, and the process may be repeated. Other methods of converting text component scores to a score for time periods may be used.

Module C1 of operation 520 may then append a new time period score to a new array, buffer, or grouping, which may be called the score history or a score segment. The score history may be a set or list which includes all time period scores calculated, either in the whole interaction, or for a specific longer length of time (e.g., wherein this specific longer length of time is ideally an integer multiple of the length of the above time periods). For example, the time period length may be 10 seconds, and the specific longer length of time is 120 seconds. In this example, the score history may include 12 values (once it has filled up 120 seconds into the interaction). In some embodiments, the score history may contain all time period scores, and as such will grow in size throughout the interaction. Whatever the form of the score history, module C1 of operation 520 may send/transfer in real time a regularly updating score history to module C2 of operation 525.

In operation 525, the regularly updating score history may be analyzed in order to extract at least one score history feature. Operation 525 or its actions may be performed by a module, engine, or sub-module C2 (e.g., as described in FIG. 8), or a suitable classification engine. Module C2 of operation 525 may form a component part of module C of operation 550. One embodiment of module C2 is described with respect to FIG. 8. Score history features may include those disclosed in relation to operation 430 of FIG. 4. The one or more score history features may then be input into a classification model. The classification model may be configured to calculate a probability or a likelihood factor that intervention is required for the interaction. The classification model may be an ML model, which may have been trained with training data of previous history features, wherein the previous history features may have been labelled to indicate whether intervention was required or not for the interaction to which they relate. The classification model may give one probability factor per one score history (for which there may be a plurality of input score history features). The probability or likelihood factors produced by the classification model may be sent/transferred in real time (e.g., shortly after they are calculated) from module C2 of operation 525 to module C3 of operation 530.

In operation 530, an intervention alert and/or priority score may be produced based on the probability or likelihood factors received from module C2, and potentially further based on calibration information received from module D (e.g., operation 535). Operation 530 or its actions may be performed by a module, engine, or sub-module C3 (e.g., as described in FIG. 9), or a suitable quality indication module. Module C3 of operation 530 may form a component part of module C of operation 550. One embodiment of module C3 is described with respect to FIG. 9. If required, module C3 may output (in real time, or all at once, e.g., in one array, after the end of the interaction) a priority score for each probability or likelihood factor received from module C2. The priority score may be the probability or likelihood factor, or the priority score may be based on the probability or likelihood factor, in that the value has been modified (e.g., a score between 0 and 1 might be converted into a word-based score between “very unsatisfactory” and “very satisfactory”). If required, module C3 may additionally/alternatively assess whether an intervention alert needs to be raised. An intervention alert may be raised if the most recently received probability or likelihood factor (and possibly a number of probabilities or likelihood factors received before the most recent one) meet some threshold conditions. The threshold conditions may be predetermined, they may be user-defined, and/or they may be received by module C3 from module D. In one example, there may be three control parameters which define the threshold conditions required to raise an alert. These may include: a probability/likelihood threshold (e.g., is a probability/likelihood above or below some value? e.g., a probability of 0.6 is above a threshold of 0.5), a number of consecutive probabilities/likelihoods to be stored for analysis (e.g., the threshold conditions may require that the previous five probabilities/likelihoods are analyzed), and/or a number of hits, which may specify how many of the probabilities/likelihoods stored for analysis are required to be above (or below) the threshold (e.g., it may be required that three of the five most recent stored/received probabilities/likelihoods lie above the threshold). In other examples, there may be one control parameter, for example, just a probability/likelihood threshold. In this example, raising an alert may be required if the latest probability/likelihood is larger than the threshold.

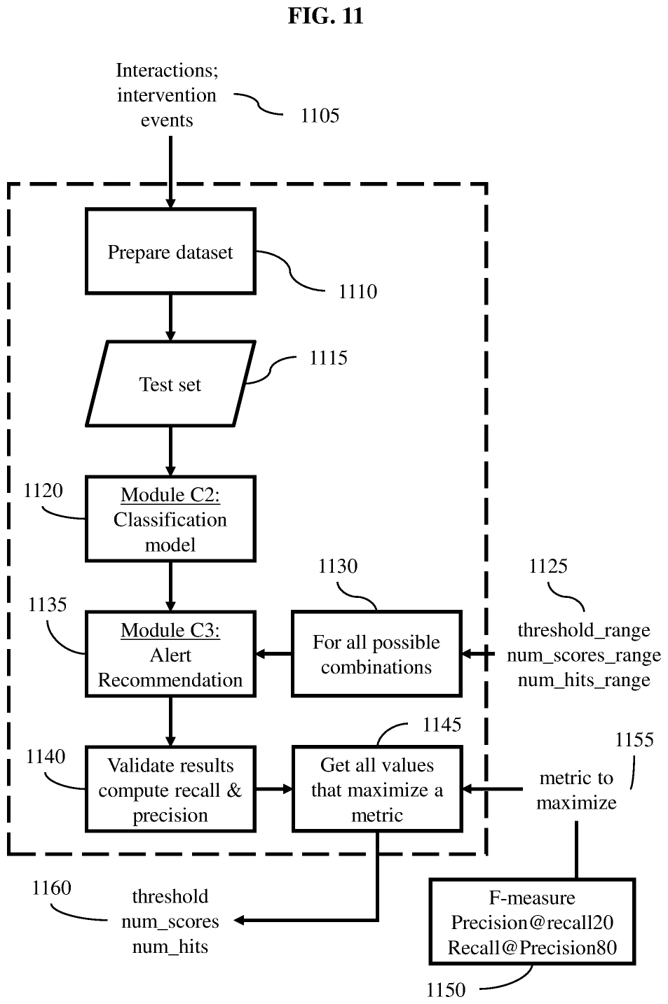

In operation 535, the threshold conditions may be calculated for module C3. Operation 535 or its actions may be performed by module or engine D (e.g., as described in FIG. 11), or a suitable calibration engine. One embodiment of module D is described with respect to FIG. 11. Choosing threshold conditions may happen once, and then these threshold conditions may be used for many interactions, if desired. A test dataset may be produced by processing example data using modules preceding module C3 in processing, or a test dataset may be produced directly. The test dataset may include probability or likelihood factors for a plurality of previous interactions, wherein it may be known whether the previous interactions required intervention. For each control parameter/condition that is required, a range of possible values may be given (e.g., for the probability threshold, possible thresholds may be given in an array as [0.1, 0.2, 0.3, 0.4, 0.5, 0.6, 0.7, 0.8, 0.9], or a smaller range of possible values may be given which may save computational resources, e.g., [0.5, 0.6, 0.7, 0.8, 0.9]). A version of module C3 may be run with the test datasets and using all possible combinations of the control parameters. Based on the outcome of running the test datasets (and comparing the results to the previous knowledge of whether an intervention was actually required), a selection of control parameters may be chosen. The control parameters may be chosen to, for example, maximize the number of true positive (e.g. label TP) results (an intervention was required and module C3 gave an output indicative of this), minimize the number of false negative (e.g. label FN) results (an intervention was required but module C3 did not indicate this), minimize false positive (e.g. label FP) results (an intervention was not required but module C3 indicated that it was), and/or maximize the number of true negative (e.g. label TN) results (an intervention was not required and module C3 gave an output indicative of this). The relative importance of the metrics above may be decided by a user/supervisor (e.g., it may be very important that false negative results are minimized). Selecting the threshold conditions/control parameters may additionally or alternatively be based on maximizing or minimizing a number of different metrics, which may be defined in terms of the metrics herein. These further possible factors may include: recall/true positive rate (e.g. label TPR), precision/positive predictive value (e.g. label PPV), specificity/true negative rate (e.g. label TNR), negative predictive value (e.g. label NPV), false negative rate (e.g. label FNR), false positive rate (e.g. label FPR), false discovery rate (e.g. label FDR), false omission rate (e.g. label FOR), positive likelihood ratio (e.g. label LR+), negative likelihood ratio (e.g. label LR-), prevalence threshold (e.g. label PT), threat score (e.g. label TS), accuracy, prevalence, an F-measure/F-score, etc. Maximizing or minimizing any or all of the above metrics may be used to select the threshold conditions/control parameters.

In operation 540, a priority score, as may have been produced by module C3, may be output or stored (e.g., output via an API or stored in memory).

In operation 545, an alert may be output if C3 indicates that this should be done (e.g., an alert may be output via an API or stored in memory). An alert may be any suitable event that may directly or indirectly get the attention of a supervisor or a relevant computer system. The alerted supervisor or computer system may consequently take remedial action.

Operation/engine 550 may be a recommendation engine, e.g., engine/module C. In general, the recommendation engine may assess an ongoing interaction, and output a real-time score regarding that interaction and/or decide whether an input interaction requires intervention from a supervisor. The recommendation engine may include the modules: C1, C2, and C3. According to some definitions, the recommendation engine may additionally carry out the steps of operations 535, 540, and/or 545. An embodiment of a recommendation Engine C is described with respect to FIG. 6.

FIG. 6 depicts the actions of a recommendation engine according to some embodiments of the invention. According to some embodiments, some or all of the components of FIG. 6 are performed (fully or partially) by one or more computational components, for example, those shown in FIGS. 1 and 2.

Component 620 shows module C1, which may be in accordance with module C1 as described with respect to FIG. 5 and FIG. 7, as well as operations 315 and 320 of FIGS. 3 and 415 and 420 of FIG. 4. Component 620 shows three consecutive segments (or score histories) being extracted from a continuous stream of time period scores and transferring these segments to Module C2. The extraction and transferring of segments may, in reality, not happen at the same time, but rather it may happen in real time, as the continuous stream of time period scores updates.

Component 625 shows module C2, which may be in accordance with module C2 as described with respect to FIG. 5 and FIG. 8, as well as operation 325 of FIG. 3 and operations 430 and 435 of FIG. 4. In component 625, features may be extracted from received segments, and these features may be input into a classification model.

Component 630 shows module C3, which may be in accordance with module C3 as described with respect to FIG. 5 and FIG. 9, as well as operation 325 of FIG. 3 and 440 of FIG. 4. In component 630, the segment/history scores/probability factors may be analyzed to assess whether an intervention alert should be raised to a supervisor (e.g., to produce an alert recommendation).

FIG. 7 is a data flow diagram of module C1 according to some embodiments of the present invention. According to some embodiments, some or all of the steps of the method/system are performed (fully or partially) by one or more computational components, for example, those shown in FIGS. 1 and 2. In FIG. 7, a score for each of a plurality of time periods of the interaction may be produced, based on the score for each text component. In other words, the score for each text component may be converted into a score for each time period of a plurality of time periods of the interaction. The operations of FIG. 7 may also include producing a score history, comprising a plurality of the time period scores. In other words, a plurality of the most recent time period scores may be grouped into a live score history. In operation 705, an ML engine, e.g., that of module B, may produce scores for each new word in a stream of words representing an interaction.

In operation 710, the word scores of operation 705 (e.g., as represented by the new_score variable) may be received and stored in a buffer or array (e.g., per_word). For example, the new_score value may be added to the per_word array (e.g., to the end).

Operation 715 may represent initial conditions of the method/system. Variables may be initialized/created such as, for example, last_score (during a time period, this may represent the score of the previous time period, i.e., the last score, and during execution of operations 725 and/or 730 at the end of a time period, last_score may represent the last/latest received score in the per_word buffer during the time period that has just happened), offset (the amount of time that has passed since the beginning of the interaction), and a per_T buffer/array (a list or array of scores for each time period (T), which may be of a certain predefined length). The per_T buffer may be output from C1 to C2 (e.g., continuously as it continues to update).

Operation 720 may execute regularly; it may repeat once every time period (T) (e.g., operation 720 may run once every 10 seconds (T=10s)). Operation 720 may ask whether the per_word buffer is empty. In other words, if the per_word buffer is empty, no new words have been received/spoken during the time period, and/or no new scores have been calculated for words during the time period. If the per_word buffer has values (scores), then these represent the scores that have been received during the time period. If the per_word buffer/array is empty, the flow diagram may move to operation 730. If the per_word buffer/array is not empty, the flow diagram may move to operation 725 (which may subsequently move to operation 730). Regardless of whether the per_word buffer is empty or not, the flow diagram may in all cases move to operation 735. Operations 720-740 may run once every time period, and at the end/beginning of a time period, operation 720 may execute again.

Operation 725 may run when operation 720 has assessed that the per_word buffer is not empty. Operation 725 may update the last_score variable to equal the last/latest score in the per_word buffer (e.g., the last_score may represent the most recent score that was received during the time period just gone) (last_score=per_word.last). Having saved a value for the last_score variable, the per_word buffer/array may be emptied/cleared. The flow diagram may then move to operation 730. In alternative embodiments. The last_score variable may be saved as an average of the per_word buffer in this step (e.g., last_score=per_word.last could be replaced with last_score=per_word.average).

Operation 730 may run after operation 725 (where at least one word score was received during the most recently ended time period), or after operation 720 (where no new word scores were received during the time period). Operation 730 may save/add the last_score variable to the per_T array/buffer; the value stored in the last_score variable may become the per_T score for the time period. In the case that the previous operation was operation 725, the effect of operation 730 may be to output the most recently received word score during the most recent time period. In the case that the previous operation was operation 720, the effect of operation 730 may be to output the same time period score as in the last iteration (e.g., the score is unchanged). When a new value is added or pushed onto the per_T buffer, an older value may automatically be removed; this may follow first-in-first-out behavior (older score values may no longer be required).

Operation 735 may represent an iteration of a counter or clock. For each iteration, the offset (the time since the beginning of the interaction) is increased by the length of the time period (e.g., where operation 720 is run once every second, T=1s, and the offset is increased by Is every iteration). The flow diagram may then move to operation 740.

Operation 740 may check whether the offset value is larger than the per_T buffer length (L) multiplied by the time period (T). As such, operation 740 may check that the per_T buffer has had opportunity to fill with relevant values from the interaction (e.g., there are no empty (meaningless) values in the per_T buffer). Once offset >L* T has been found to be true for an interaction, it may not be necessary to check this condition again. Operation 740 may additionally check that the offset is an integer multiple of some integer value (t). If t=3, then the data flow diagram will only output a per_T buffer every third time period (T). If the above conditions are met, data may be passed to the classification engine 745 (and feature extraction) that may relate to module C2. The data that is transferred to operation 745 is the per_T buffer (or score history).

FIG. 8 is a data flow diagram of module C2 according to some embodiments of the present invention. According to some embodiments, some or all of the steps of the method/system are performed (fully or partially) by one or more computational components, for example, those shown in FIGS. 1 and 2.

In operation 805, module C2 may receive ML scores, for example in the form of a time period score history, for example, the score history output by operations 740 and 745 of FIG. 7.

In operation 810, module C2 may prepare feature or characteristic values, e.g., based on the received score history. One or more features or characteristics (score history features) may be calculated or obtained from the score history or live score history. Examples of features (score history features) may include:
“min”—the lowest score in the score history/buffer,
“max”—the highest score in the score history/buffer,.
“mean”—the mean average of the scores in the score history/buffer,.
“median”—the median average of the scores in the score history/buffer,.
“diff”—the difference between the highest and the lowest scores in the score history/buffer.
“trend”—the difference between the mean average (or other average) of the second and the first halves of the score history/buffer,
a list of raw scores,

In operation 815, module C2 may use the feature values as an input for a classification model. Operation 815 may additionally be based off other features, for example, experience or skills of the relevant agent (e.g., it may be known that the agent is relatively new, and as such, may be more likely to require intervention), or an “offset” or time elapsed since the beginning of a interaction/call (e.g., negative scores later in an interaction may be more concerning). Operation 815 may calculate a probability of required intervention based on the at least one score history feature value. The probability of required intervention may not in some embodiments correspond to an actual probability that intervention actually takes place or is deemed necessary by the contact center (although in other embodiments it might do). The probability of required intervention may be an intervention likelihood factor, an intervention factor, or similar. The probability of required intervention may be calculated using the classification model, which may be an ML model. The ML model may have been trained with a number of one or more score history features (as training data). Training data may have been labeled with a likelihood that intervention is required for each input set of history feature values. For example, one piece of training data may indicate that, if there is a strong negative “trend” (e.g., the scores are dropping rapidly), this may indicate a high probability that intervention is required. Operation 815 may output an intervention factor per score history received (which may be, for example, once every three time periods).

In operation 820, probability of required intervention or probability to intervene may be transferred/sent to module C3 (e.g., as described with respect to FIG. 9).

FIG. 9 is a data flow diagram of module C3 according to some embodiments of the present invention. According to some embodiments, some or all of the steps of the method/system are performed (fully or partially) by one or more computational components, for example, those shown in FIGS. 1 and 2.

In operation 905, module C3 may receive a probability of required intervention/intervention factor from the classification engine of module C2, e.g., as calculated in operation 815.

In operation 910, the intervention factor may be saved/added/pushed to a buffer/array (a different buffer/array to those described thus far). In some embodiments, the buffer/array may have a relatively smaller size compared to other buffers/arrays that have been discussed. For example, the buffer/array of operation 910 may have a size of 5. The size of the buffer/array may have a size that conforms to the size calculated in a calibration process, such as the calibration process operation 945 or the calibration process described in FIG. 11. The flow diagram may then move to operation 915.

In operation 915, it may be determined whether the buffer (e.g., as discussed herein) is full. For example, the buffer may be full if the interaction has run a long enough time that a number (e.g., 5, as discussed herein) of intervention factors may have been produced. If the buffer is full, the flow diagram may move to operation 920 and/or operation 930 (in some embodiments, both discussed indications of interaction quality (priority score and alert) are produced, in some embodiments one is produced, and in other embodiments other indications of quality may be output). If the buffer is not full, the flow diagram may wait until more intervention factors are received from module C2.

In operation 920, a priority score/indication may be produced/calculated. For example, the priority score may be the average (e.g., mean) of all intervention factors in the buffer. The flow diagram may move to operation 925.

In operation 925, the priority score/indication calculated in operation 920 may be output. For example, the priority score may be output via an output device, or through a network.

In operation 930, a count may be calculated, based on a received threshold (e.g., as received from operation 945). The count may be the number of factors, of those stored in the buffer (of the given size), that are higher than the threshold value. For example, if the buffer is [0.7, 0.6, 0.45, 0.9. 0.3, 0.3], and the threshold is 0.65, then the count is 2 (0.7 and 0.9 are higher than the threshold). The flow diagram may then move to operation 935.

Operation 935 may assess whether the count is more than or equal to a no_hits or number of hits calibration factor. For example, carrying on from the example above, if no_hits =2, and given that count was found to be 2, then operation 935 will assess that the statement “count ≥no_hits” is true. If operation 935 finds that the count is more than or equal to the number of hits calibration factor (e.g., as calculated in operation 945), then the flow diagram may move to operation 940.

In operation 940, an alert/intervention alert may be output. The alert may be output to a supervisor. The alert may be output via an output device, network device, API, etc. The alert may be text-based or partially text-based, e.g., “An ongoing interaction requires your attention”.

Operation 945 may calculate/provide threshold conditions/calibration factors/control parameters/control heuristics. These control parameters may be required, directly or indirectly, for operations 910, 930, and/or 935. There may be three control parameters which define the threshold conditions required to raise an alert. These may include: a probability/likelihood threshold (e.g., is a probability/likelihood above or below some value? e.g., a probability of 0.6 is above a threshold of 0.5) as may be required by operation 930, a number of consecutive probabilities/likelihoods to be stored for analysis (or the size of the buffer) (e.g., the threshold conditions may require that the previous five probabilities/likelihoods are analyzed) as may be required for, or to set up, operation 910, and/or a number of hits (no_hits), which may specify how many of the probabilities/likelihoods stored for analysis are required to be above (or below) the threshold (e.g., it may be required that three of the five most recent stored/received probabilities/likelihoods lie above a probability threshold of 0.8), as may be required by operation 935. The threshold calibration of operation 945 may only need to be run once for a number of interactions. Operation 945 may send/transfer the parameters to operations 910, 930, and/or 935, as is required.

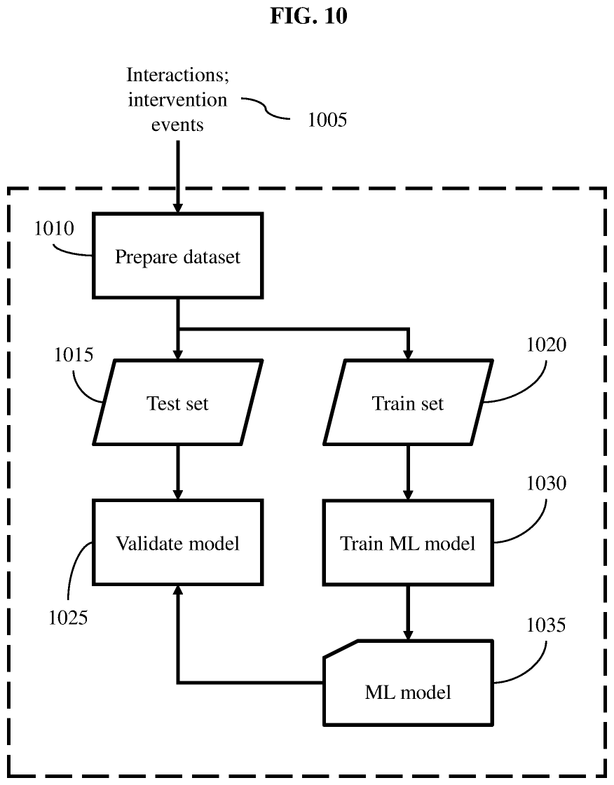

FIG. 10 is a data flow diagram describing the training process of ML models (e.g., classification models) according to some embodiments of the present invention. For example, FIG. 10 may describe the process of training the classification model of module C2, and/or the scoring model/system of module B, and/or the text extraction model/system of module A. According to some embodiments, some or all of the steps of the method/system are performed (fully or partially) by one or more computational components, for example, those shown in FIGS. 1 and 2.

In operation 1005, a number of interactions may take place and/or be recorded. These interactions may or may not require intervention from a supervisor. Whether or not an interaction was required may be recorded/saved.

In operation 1010, data indicative of recorded interactions, e.g., recording transcripts and possibly further metadata (e.g., volume levels), may be prepared into a plurality of datasets representing a plurality of interactions. The datasets may include at least one training dataset 1020, which may be used to train an ML model. The datasets may include at least one test dataset 1015, which may be used to test, e.g., the efficacy of the ML once it has been trained. A dataset may comprise a plurality of interactions, wherein the interactions may be associated with one or more of the following data points: a unique identifier of the interaction (interaction ID) (e.g., an integer), an array of scores for the interaction (e.g., the array shows the scores of the interaction over time during the interaction), whether an intervention was required (e.g., stored as a Boolean value), and an intervention event time (where applicable) (this may represent at which point during an interaction an intervention was actually taken and/or was required) (e.g., a floating point number).

In operation 1030, any suitable ML model 1035 may be trained using the training dataset, as has been discussed previously. Suitable ML models may include, for example, (artificial) neural networks (NN), decision trees, regression analysis, Bayesian networks, Gaussian networks, genetic processes, etc. Training may, for example, be supervised or unsupervised.

The ML model 1035 may then be validated and/or improved using the test dataset. For example, the test dataset may contain data indicative of interactions, which may be input into the ML model. The ML model may output an indication of the quality of the interaction. The test dataset may additionally include a known indication of the quality of the interaction. The output of the model may be compared to the known values in order to evaluate the success/efficacy of the model. For example, it may be found that the model produces the correct answer for 90% of the test dataset. Different models may be compared (e.g., as trained using different datasets) using the model efficacies.

FIG. 11 is a data flow diagram of module D according to some embodiments of the present invention. Module D may be used to calibrate module C3. According to some embodiments, some or all of the steps of the method/system are performed (fully or partially) by one or more computational components, for example, those shown in FIGS. 1 and 2. Choosing threshold conditions may happen once, and then these threshold conditions may be used for many interactions, if desired.

In operation 1105, a number of interactions may take place and/or be recorded. These interactions may or may not require intervention from a supervisor. Whether or not an interaction was required may be recorded/saved.

In operation 1110, data indicative of recorded interactions, e.g., recording transcripts and possibly further metadata (e.g., volume levels), may be prepared into at least one test dataset 1115 representing a plurality of interactions.

Each interaction of the test data set may be input into module C2 in operation 1120. Module C2 may be as described in, for example, FIG. 8. Operation 1120 may output a plurality of probabilities to intervene. There may be multiple probabilities to intervene per interaction, as may happen in normal operation of module C2, and these multiple probabilities may be stored in an array (alternatively, the process may be modified such that one score history of a whole interaction is input into operation 1120, such that one probability to intervene is produced per one interaction).

For each control parameter/condition that is required 1125, a range of possible values may be given (e.g., for the probability threshold, possible thresholds may be given in an array as [0.1, 0.2, 0.3, 0.4, 0.5, 0.6, 0.7, 0.8, 0.9], or a smaller range of possible values may be given which may save computational resources, e.g., [0.5, 0.6, 0.7, 0.8, 0.9]). The required control parameters or conditions that are required may include a threshold, a number of scores to be considered/buffer size, and a number of hits, as have been discussed previously. Each of the control parameters may be given a range of possible values. For example, a probability threshold range may be [0.5, 0.6, 0.7, 0.8, 0.9], a buffer size range may be [4, 5, 6, 7, 8], and a number of hits range may be [2, 3, 4, 5].

There may be a number of possible combinations 1130 of possible ranges of control parameters. All possible combinations may be constructed, and possibly stored, e.g., in an array. For the example ranges used above there may be 5*5*4=100 possible combinations of control parameter values. However, in some embodiments, some number of hits values may be incompatible with buffer size values. In the above embodiments, a number of hits value of 5 may be incompatible with a buffer size of 4, as it would be impossible to achieve 5 hits. These impossible/incompatible combinations may be discarded. In the above example, there may be 5*1*1=5 incompatible/impossible combinations. Therefore, there may, in fact, be 100−5=95 possible combinations of control parameters.

In operation 1135, module C3 may be executed with inputs of the plurality of probability values for a plurality of interactions, which may each be run for the plurality of control parameter combinations. Operation 1135 may produce a number of values representing whether or not in normal operation, given the example control parameters it used for a certain iteration, operation 1135 would have raised an intervention alert for the interactions in question. It may be known whether an interaction was actually required for each interaction.

In operation 1140, the results of operation 1135 may be validated, and/or a recall and precision value may be calculated for each combination of control parameters. Each of the results for whether operation 1135 would raise an alert, may be compared to or validated against a known value for whether an alert should actually have been raised. The known value for whether an alert should actually have been raised may be as assessed by a supervisor. For example, it may be known that in one of the previous interactions in the dataset, a supervisor intervened in the interaction (e.g., by taking over the call). The validation may assess multiple different metrics. For example, the validation may involve calculating the number of true positive TP results (an intervention was required and operation 1135 gave an output indicative of this), the number of false negative FN results (an intervention was required but operation 1135 did not indicate this), the number of false positive FP results (an intervention was not required but operation 1135 indicated that it was), and/or the number of true negative TN results (an intervention was not required and operation 1135 gave an output indicative of this). From these values, the recall and/or precision may be calculated. These may be calculated using, for example:

$$Recall = \frac{TP}{TP + FN} , and \\ Precision = \frac{TP}{TP + FP} .$$

Other metrics may additionally or alternatively be calculated, for example, recall/true positive rate (TPR), precision/positive predictive value (PPV), specificity/true negative rate (TNR), negative predictive value (NPV), false negative rate (FNR), false positive rate (FPR), false discovery rate (FDR), false omission rate (FOR), positive likelihood ratio (LR+), negative likelihood ratio (LR-), prevalence threshold (PT), threat score (TS), accuracy, prevalence, an F-measure/F-score, etc. An F-measure may be calculated using, for example:

$$F = 2 \cdot \frac{recall \cdot precision}{recall + precision} .$$

Operations 1150 and 1155 may decide on a metric to be maximized or minimized (for conciseness only maximization is referred to explicitly herein, but in some embodiments, minimization may be used). For example, operation 1150 gives some examples of metrics to be maximized of the F-measure, maximizing a precision at a given recall value of 20%, or maximizing a recall at a given precision value of 80%. Many more/alternative possibilities may be used. The metrics that are chosen to be used may be based on user preference. For example, it may be more important for a contact center to minimize false negatives than it is to minimize false positives (e.g., it may be very important that very few interactions are unsatisfactory, e.g., the contact center must maintain a strong reputation for service). Consequently, the contact center may choose to maximize recall (possibly given a minimum value for precision). By way of another example, it may be more important for a contact center to minimize false positives than it is to minimize false negatives (e.g., it may be very important to preserve resources, e.g., the contact center may have few supervisors, so it may be important that their time is not wasted). In this example, the contact center may choose to maximize precision (possibly given a minimum value for recall).

Operation 1145 may evaluate the results from operation 1140 to find which combination of control parameters maximizes the metrics as decided by operations 1150 and 1155. For example, given the data from operation 1140, it may be found that the combination of control parameters that maximizes an F-measure for the interactions that have been given is [probability threshold=0.8, buffer size=6, number of hits=4]. These control parameters may be used in module C3 of normal operation of the invention. They may be output or stored, as in operation 1160.

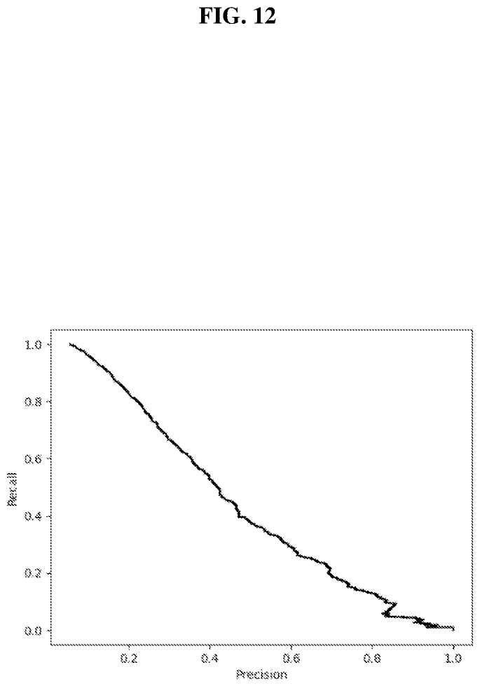

FIG. 12 depicts an example of results produced during a calibration process of the present invention. The results may be as discussed during step 1140 of FIG. 11. For a group of interactions, and for multiple control parameter combinations, a recall and a precision value may be calculated. Each point on the graph of FIG. 12 may correspond to a different control parameter combination. The graph of FIG. 12 may be helpful in visually representing operation 1145, e.g., to maximize recall given a minimum precision of 0.2 (20%), a vertical line may be drawn at precision=0.2, and where this line intersects with the data may be a point indicative of ideal control parameters for use in the invention (according to a user's preference). The specific data shown in FIG. 12 was produced using 600 previously recorded interactions, 150 of which required an intervention.

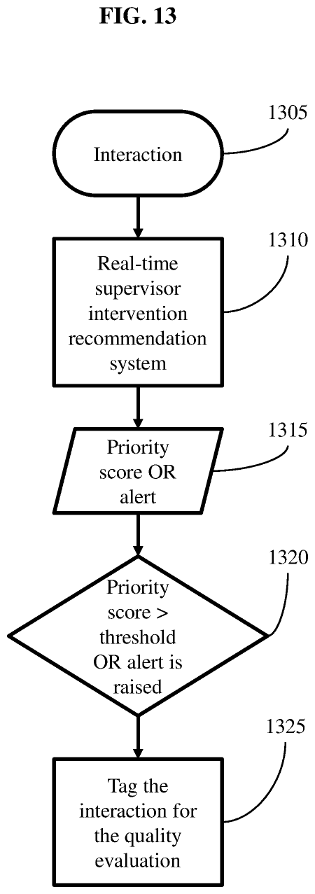

FIG. 13 is a data flow diagram describing automatic tagging of unsatisfactory interactions according to embodiments of the present invention. According to some embodiments, some or all of the steps of the method/system are performed (fully or partially) by one or more computational components, for example, those shown in FIGS. 1 and 2. Choosing threshold conditions may happen once, and then these threshold conditions may be used for many interactions, if desired.

In operation 1305, an interaction may take place/be recorded.

In operation 1310, data indicative of the interaction may be input into a real-time supervisor intervention recommendation system, such as the system described in any or all of FIGS. 3-11. Operation 1310 may be configured to output a priority score or raise an alert 1315.

In operation 1320, it may be assessed whether the priority score is above (or below) some threshold, wherein a priority score above (or below, as the case may be) the threshold may indicate that an interaction is potentially unsatisfactory. Additionally or alternatively, operation 1320 may assess whether an intervention alert has been raised by operation 1310 (which may also indicate that an interaction is potentially unsatisfactory).

If either of the above conditions is true, then in operation 1325 the interaction concerned may be tagged. A tagged interaction may be evaluated further. For example, it may be wished to understand why an interaction was unsatisfactory.

Systems and methods of the present invention may improve existing interaction monitoring technology. For example, workflow may be automated; interaction interventions may be made earlier; interaction interventions may be more effective; interaction inventions may be made preemptively; there may be greater accuracy as to which interactions require an intervention; supervisor productivity may be improved; a supervisor may spend less time monitoring interactions which require no intervention, as interactions are automatically monitored; there may be increased computational efficiency overall; and there may be savings in time overall.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for automatic real-time monitoring of interactions, carried out by at least one computer processor, the method comprising:
producing a score for each text component of a text representation of an interaction;
producing, based on the score for each text component, a score for each of a plurality of time periods of the interaction; and
producing a score history, comprising a plurality of the time period scores;
calculating, based on the score history, a real-time indication of the quality of the interaction.

2. The method according to claim 1, further comprising:
extracting from a recording or data stream of an interaction, a text representation of the interaction, wherein the text representation comprises a plurality of text components.

3. The method according to claim 1, wherein producing the score for each text component is based on at least one metric and further comprises:
inputting the text components into at least one score machine learning engine configured to produce a score based on the metric, wherein the at least one metric is at least one of: a customer sentiment, an agent sentiment, a customer behavior, and an agent behavior; and
receiving from the at least one engine, scores for each text component.

4. The method according to claim 1, wherein producing the score for each text component is based on the text component and a number of preceding text components in the interaction.

5. The method according to claim 4, wherein producing the score for each time period based on the score for each text component comprises, for each time period:
where no new text component score is produced in the time period, outputting a most recent text component score;
where a new text component score is produced in the time period, outputting the last such text component score.

6. The method according to claim 1, wherein the at least one score history feature comprises at least one of:
a minimum score in the score history;
a maximum score in the score history;
a mean score of the score history;
a median score of the score history;
a difference between the maximum score and the minimum score; and
a difference between a mean of a second half of the score history and a mean of the first half of the score history.

7. The method according to claim 1, wherein calculating a real-time indication of the quality of the interaction comprises:
calculating, based on the score history, at least one score history feature;
calculating, based on the at least one score history feature, a probability of required intervention;
calculating, based on the probability of required intervention, and further based on at least one control parameter, a real-time indication of the quality of the interaction.

8. The method according to claim 7, wherein the at least one control parameter comprises at least one of:
a probability threshold;
a number of consecutive scores stored; and
a number of above-threshold scores.

9. A system for automatic real-time monitoring of contact center interactions, the system comprising:
a memory; and
at least one processor configured to:
produce a score for each text component;
produce, based on the score for each text component, a score for each of a plurality of time periods of the interaction;
produce a score history, comprising a plurality of the time period scores;
calculate, based on the score history, at least one score history feature; and
calculate, based on the at least one score history feature a real-time indication of the quality of the interaction.

10. The system according to claim 9, wherein the at least one processor is further configured to:
extract from a recording or data stream of an interaction, a text representation of the interaction, wherein the text comprises a plurality of text components.

11. The system according to claim 9, wherein the at least one processor is configured to produce the score for each text component based on at least one metric, and wherein the at least one processor is further configured to:
input the text components into at least one score machine learning engine configured to produce a score based on the metric, wherein the at least one metric is at least one of: a customer sentiment, an agent sentiment, a customer behavior, and an agent behavior; and
receive from the at least one engine, scores for each text component.

12. The system according to claim 9, wherein the score for each text component is based on the text component and a number of preceding text components in the interaction.

13. The system according to claim 12, wherein to produce the score for each time period based on the score for each text component, the at least one processor is further configured for each time period to:
where no new text component score is produced in the time period, output a most recent text component score;
where a new text component score is produced in the time period, output the last such text component score.

14. The system according to claim 9, wherein the at least one score history feature comprises at least one of:
a minimum score in the score history;
a maximum score in the score history;
a mean score of the score history;
a median score of the score history;
a difference between the maximum score and the minimum score; and
a difference between a mean of a second half of the score history and a mean of the first half of the score history.

15. The system according to claim 9, wherein, to calculate a real-time indication of the quality of the interaction, the at least one processor is further configured to:
calculate, based on the score history, at least one score history feature;
calculate, based on the at least one score history feature, a probability of required intervention;
calculate, based on the probability of required intervention, and further based on at least one control parameter, a real-time indication of the quality of the interaction.

16. The system according to claim 15, wherein the at least one control parameter comprises at least one of:
a probability threshold;
a number of consecutive scores stored; and
a number of above-threshold scores.

17. A method for live monitoring of interactions, carried out by at least one processor, the method comprising:
generating a text representation of an interaction;
evaluating each of a plurality of text components of the text representation to produce a score for each text component;
converting the score for each text component into a score for each time period of a plurality of time periods of the interaction;
grouping a plurality of the most recent time period scores into a live score history;
obtaining at least one score history characteristic from the live score history;
obtaining an indication of a probability that interaction intervention is required based on the at least one score history characteristic; and
outputting the probability that interaction intervention is required using a computer output device.

18. The method according to claim 17, wherein generating a text representation of the interaction comprises: inputting a sound-based representation of the interaction into a speech-to-text algorithm.

19. The method according to claim 17, wherein evaluating each of the plurality of text components comprises:
inputting the text representation of the interaction and at least one scoring metric into a scoring algorithm, wherein the scoring metric comprises at least one of: a customer sentiment, an agent sentiment, a customer behavior, and an agent behavior.

20. The method according to claim 17 wherein the interaction comprises at least one of: a voice telephone call, a conference call, a video recording, a face-to-face interaction, an email, a web chat, and an SMS message.
